(19) United States
(12) Patent Application Publication
(10) Pub. No.: US 2021/0330997 A1
(43) Pub. Date: Oct. 28, 2021

(54) Plurisensorial System Adapted for the Prevention of Professional Diseases in the Working Environment, and Method for the Use of the System

(71) Applicant: POLITECNICO DI MILANO, Milano (IT)

(72) Inventors: Venere Ferraro, Milano (IT); Silvia Deborah Ferraris, Milano (IT); Giuseppe Andreoni, Milano (IT); Kaspar Jansen, The Hague (NL); Alessia Moltani, Milano (IT); Alba Cappellieri, Milano (IT); Mila Stepanovic, Milano (IT)

(21) Appl. No.: 16/625,548

(22) PCT Filed: Jun. 28, 2018
(86) PCT No.: PCT/IB2018/054813

§ 371 Date: Dec. 20, 2019

(30) Foreign Application Priority Data
Jun. 29, 2017 (IT) 102017000072994

(51) Int. Cl. A62B 9/00; G08B 21/18; A62B 23/02; A62B 18/10

(52) U.S. Cl. CPC A62B 9/006; G08B 21/182; A41D 13/11; A62B 18/10; A62B 23/02

(57) ABSTRACT

A multi-sense system adapted for prevention of occupational diseases in a working environment includes a protective facial mask adapted for application in the front zone of a person's face, having nose and mouth areas, and including: —a temperature and humidity sensor adapted to be activated when the mask is worn, and adapted to provide time-related data concerning the activation as well as temperature and humidity values; —removable air filter elements applied to the front side parts of the mask; —inhalation and exhalation valves applied to the front zone of the mask, in front of the mouth, when the mask is worn; —elements for securing the mask to the face; —an electronic nose device adapted to provide, when worn by the person, time-related data about the quality of the air in the working environment; —a breathing detection device, adapted to provide, when worn by the person, time-related data about the respiratory rate; —a data processing and displaying device, adapted to receive and store the data outputted by the protective facial mask, electronic nose device and breathing detection device, also adapted to process and display the data in order to determine a condition wherein the protective facial mask needs to be worn.

### FIELD OF THE INVENTION

The present invention relates to a plurisensorial system adapted for the prevention of professional diseases in the working environment, and to a method for the use of the system.

### BACKGROUND ART

Care and monitoring aimed at improving the quality of workers' health is a primary goal, also dictated by regulations about safety in working environments that must be complied with. Data made available by international bodies have shown that, in the manufacturing field, particularly in painting facilities, there is a very high incidence of respiratory diseases (e.g. lung and pleura cancer, asthma, infectious diseases of the respiratory tract). This is due, at least partly, to problems related to the fact that workers do not use individual protection devices.

Tests carried out have shown that, statistically, the percentage of workers not using a respiratory safety mask is too high, essentially for two reasons:

comfort reason: the mask is heavy and irritates the skin, the loop around the ears and the head is disturbing, materials are not suitable for prolonged use without causing a repulsive reaction;
habituation reason: after some time the worker no longer perceives the odours in the working environment: his olfaction gets accustomed to the environment. The danger deriving from this situation is that the worker will base his own decision to either wear the mask or not on whether he is perceiving any smell or not, thus exposing himself to higher risk because he has become accustomed to the odour.

There is therefore a need for finding new ways of using the technology for supporting the worker and leading him to use individual protection devices (IPD). It is also necessary to find adequate means for protecting workers in dangerous environments, such as painting facilities, while at the same time increasing their awareness of the risks they are exposed to.

### SUMMARY OF THE INVENTION

It is therefore an object of the invention to propose a plurisensorial (multi-sense) system adapted for the prevention of professional diseases in the working environment, and a method for the use of the system, aimed at overcoming the above-described problems.

It is one goal of the invention to propose a system for protecting workers in dangerous environments, e.g. painting facilities, also for the purpose of increasing their awareness of the risks they are exposed to if they do not adopt appropriate prevention systems.

The system of the invention is based on environmental and personal monitoring. This monitoring is used in order to give real-time information and create a database providing the workers with all the necessary information about the environment in which they are working and about vital parameters.

The real-time information provided by the system warns the user when a protection device, such as a safety mask, needs to be worn, and is based on the monitoring of parameters such as the quality of the air. The information including air quality, frequency of mask use and vital parameters are stored into a mobile application, wherein the data are represented graphically to facilitate reading. This information is supplied to the users on a daily basis, and is also available as weekly and monthly statistics, so that the workers can become aware of the progress made.

The present invention relates to a multi-sense system adapted for prevention of occupational diseases in a working environment, comprising:

a protective facial mask, adapted for application in the front zone of a person's face, comprising nose and mouth areas, and comprising:
a temperature and humidity sensor adapted to be activated when the mask is worn, and adapted to provide time-related data concerning said activation as well as temperature and humidity values;
removable air filter elements applied to the front side parts of the mask;
inhalation and exhalation valves applied to the front zone of the mask, in front of the mouth, when the mask is worn;
elements for securing the mask to the face;
an electronic nose device adapted to provide, when worn by the person, time-related data about the quality of the air in said working environment;
a breathing detection device, adapted to provide, when worn by the person, time-related data about the respiratory rate;
a data processing and displaying device, adapted to receive and store the data outputted by said protective facial mask, electronic nose device and breathing detection device, also adapted to process and display said data in order to determine a condition wherein said protective facial mask needs to be worn.

It is a particular object of the present invention to provide a plurisensorial system adapted for the prevention of professional diseases in the working environment, and a method for the use of the system, as described in detail in the claims, which are an integral part of the present description.

### BRIEF DESCRIPTION OF THE DRAWINGS

Further objects and advantages of the present invention will become apparent from the following detailed description of a preferred embodiment (and variants) thereof referring to the annexed drawings, which are only supplied by way of non-limiting example, wherein:

FIGS. 1 and 2 shows an embodiment of the protective mask, which is a part of the present invention, respectively as an exploded view of its components and as an assembly;

FIG. 3 shows an embodiment of the electronic nose device;

FIGS. 4 and 5 show some examples of displays of data detected by the components of the system according to the invention.

In the drawings, the same reference numerals and letters identify the same items or components.

### DETAILED DESCRIPTION OF SOME EMBODIMENTS

The multi-sense system of the invention essentially comprises:

Protective facial mask
Electronic nose device
Breathing detection device
Data processing and displaying device.

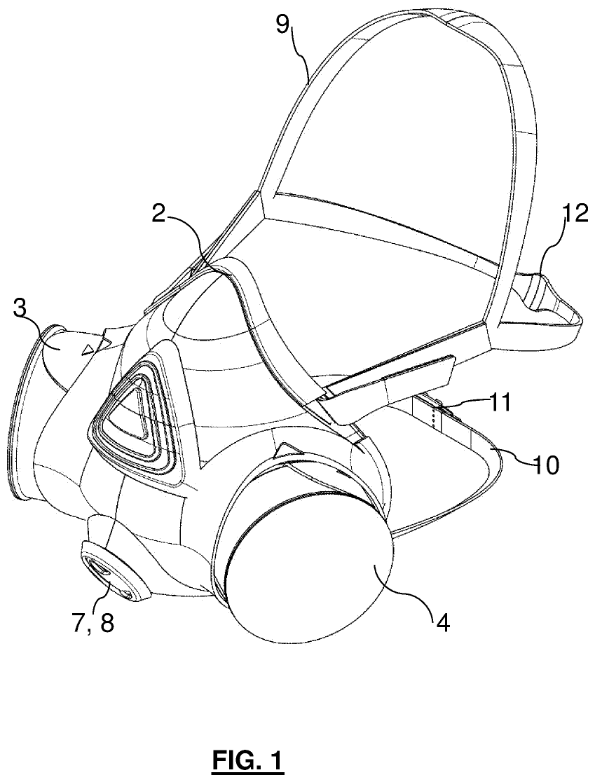

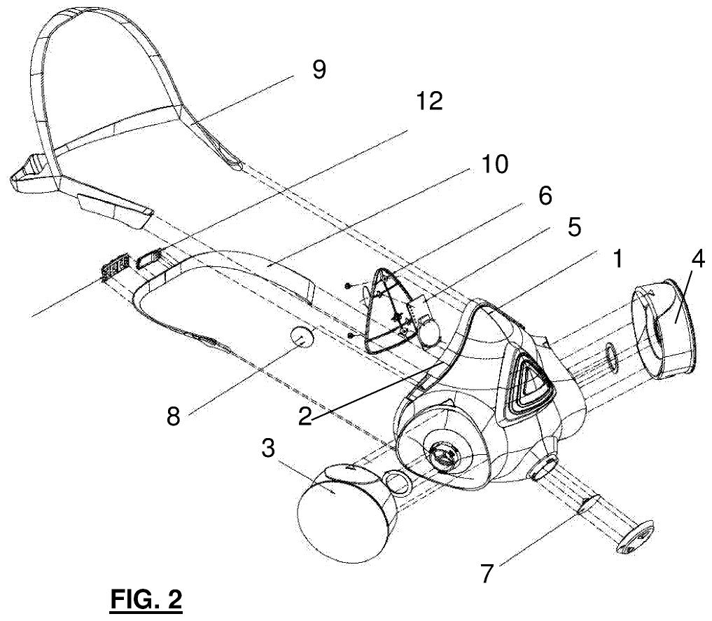

The protective mask (FIGS. 1 and 2) essentially comprises the following components:

a mask element 1 made of plastic material, e.g. PP or TPE, shaped for application to the front part of the face, in the area including the nose and the mouth;
a seal 2 applied to the rear edge of the mask element to ensure adhesion thereof to the face;
two filtering cartridges 3, 4 applied to the two front side parts of the mask element, and containing removable air filters;
an element 5, 6 acting as a humidity and temperature sensor and also as a switch; it is applied to the upper rear part of the mask, so that, when the mask is worn, the switch will go on, providing a presence indication on the person's face;
inhalation 8 and exhalation 7 valves applied to the front zone of the mask, in front of the mouth, when the mask is worn;
laces 9, 10, with respective opening and closing hooks 11, 12, for fastening the mask to the face.

The basic purpose of the reusable personal protective mask is to protect the user.

The function of the temperature and humidity sensor 5, 6 integrated into the mask is to monitor the person's breathing and to check that the mask has been worn correctly, especially when the air in the working environment exceeds admissible VOC (Volatile Organic Compounds) values. When the mask comes in contact with the face, the sensor will automatically turn on. Every time the sensor is turned on, presence, temperature and humidity information is sent to the data processing and displaying device, e.g. via a Bluetooth connection. The sensor is small, and therefore discreet and light.

The seal 2 acts as a spacer, preferably made of thermoformed fabric padded with soft foam; this material is better tolerated than those known in the art, such as rubber, which is one of the reasons why the mask is felt as uncomfortable and is not regularly worn by the workers. The filtering cartridges 3, 4 comprise a light plastic support, wherein the amount of plastic used in the protective mask is lower than in prior-art masks, resulting in lower weight and less material waste. The filtering cartridges comprise filtering material that constitutes a barrier against polluting substances, which is made of thermoformed non-woven fabric containing activated carbons, also useful for smell reduction purposes.

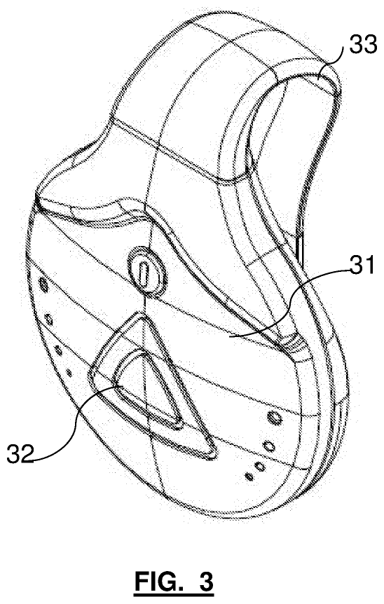

It should therefore be noted that most of the mask components, i.e. removable filters, laces and hooks (save for the front part, made of plastic material), are made of textile materials. The electronic nose device 31 (FIG. 3) provides real-time information about the quality of the air in the working environment. It contains a VOC value sensor (sensing volatile organic compounds, such as gas, alcohol, carbon monoxide). It also contains a LED signal generator with an external display element 32 and a vibration generator.

Based on the VOC levels detected, the device outputs information on three-levels: turning on of the green LED, meaning that the VOC value is below the threshold, i.e. an acceptable situation; turning on of the yellow LED and light vibration, meaning a situation requiring attention due to the risk of exceeding the maximum VOC value; turning on of the red LED and strong vibration, meaning a situation in which the maximum VOC value has been exceeded, so that there is an actual danger for the worker, who must therefore wear the mask.

This device is easy to wear by means of a clip 33 that can be fastened, for example, to the pants belt or in another comfortable position, and is effective because the worker is almost compelled to perceive its signals: should he not be looking at the signal light, he will nevertheless feel the vibration, since the electronic nose is in contact with his body.

The measured air quality parameters are monitored and transmitted to the data processing and displaying device, e.g. via a Bluetooth connection.

De facto, the electronic nose replaces the human nose in providing a correct detection, thus avoiding the above-described olfactory habituation phenomena.

A non-limiting example of the electronic nose device is described in international patent application no. PCT/EP2018/062214, filed on Nov. 5, 2018 by the present applicant, which is to be understood as fully incorporated into the present description.

The essential features of the device described in said application are the following, as set out

Wearable device for monitoring gaseous pollutants, comprising:

a. a container shell
b. a gaseous pollutant sensor;
c. a luminous signal and/or vibration generator;
characterized in that said sensor b) is operationally connected to said generator c), and said generator c) generates said luminous signal and/or vibration as a function of the signal generated by said sensor b).

Preferably, said gaseous pollutant sensor device b) is a sensor of volatile organic compounds and/or carbon oxides, in particular carbon dioxide.

The breathing detection device is preferably shaped as a thoracic belt for monitoring the user's respiratory rate.

It can be made in a per se known manner. For example, it may consist of the CMF 162165BELT belt developed by company Comftech s.r.l.

The detected respiratory rate data are sent to the data processing and displaying device, e.g. via a Bluetooth connection.

The data processing and displaying device comprises a software application, e.g. residing in one or more mobile devices, though it may also reside in other types of devices, e.g. a desktop or laptop PC.

The device stores all the above-described data collected: for example, frequency of use of the protective mask, VOC value in the air, indicating the quality of the air (electronic nose device), respiratory rate (breathing detection belt).

All data can be organized into graphs, e.g. bar graphs, in three colours: green, yellow and red to indicate the success rate for each measurement over time. In this manner, all data are interpolated, and it can be seen how each datum affects the others, and how the quality of the air and the frequency of use of the mask affect the vital parameters. The data can be generated on a daily, weekly and monthly basis, and statistics can also be generated, presented as a pie chart.

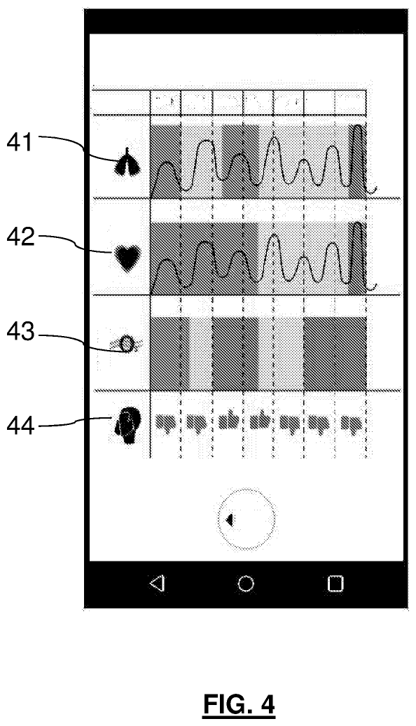

It is thus possible to obtain constant information about the parameters detected over the span of a day, e.g. breathing, heart, air quality, so that the worker is made to understand that when he is not wearing the mask the quality of his breathing gets worse (lung, air, heart, mask data graphs). Lung 41, heart 42, air 43 and mask 44 icons are preferably shown (FIG. 4) beside the graphs.

Two types of applications are preferably present, respectively dedicated to the employer and to the personnel.

The application for the personnel (FIG. 4 shows one type of data display) stores all information providing images in graphic form, wherein the parameters are organized vertically to facilitate reading.

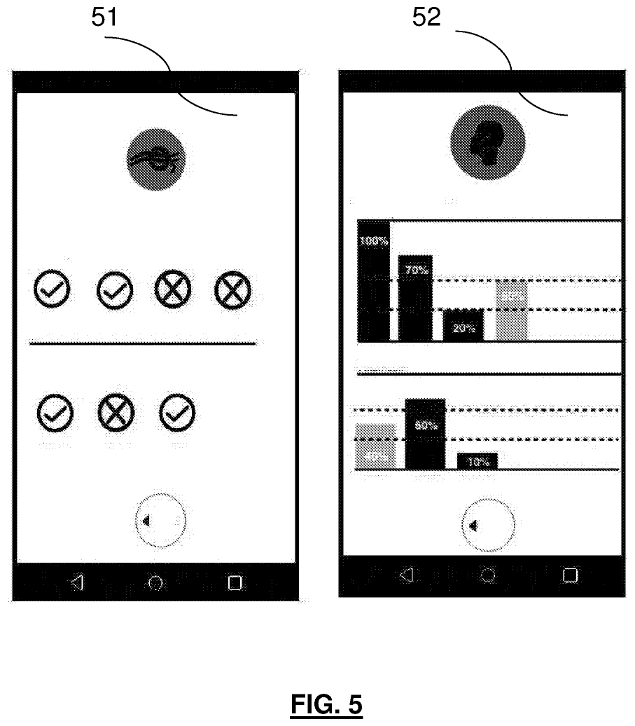

The application for the employer (FIG. 5) provides two types of values: the quality of the air (display 51) and the frequency of use of the protective mask (display 52). By evaluating these data, the employer can understand if his facility has good ventilation, and also if the workers are wearing the mask whenever necessary.

The system of the invention allows preventing occupational diseases, and is a novel approach to professional personal protection, the goal of which is not only to protect the worker, but also to increase the latter's awareness of the risks of his working activity.

The mask is an improvement over and is more comfortable than prior-art types. The electronic nose is useful both for the employer, in order to understand if the facility is working well, and for the worker, in order to understand when it is absolutely necessary to wear the mask. The breath-detecting thoracic belt is useful for the worker to know his own fatigue level, and hence to understand that his own health worsens when he is not using the mask.

The operator always wears both the breathing detection device and the electronic nose. He will also wear the mask whenever necessary.

The programming language of the above-described software applications may be any one known to the person skilled in the art.

The above-described non-limiting example of embodiment may be subject to variations without departing from the protection scope of the present invention, including all equivalent designs known to a man skilled in the art.

The elements and features shown in the various preferred embodiments may be combined together without however departing from the protection scope of the present invention.

From the above description, those skilled in the art will be able to produce the object of the invention without introducing any further construction details.

1. A multi-sense system adapted for prevention of occupational diseases in a working environment, comprising:
a protective facial mask, adapted for application in the front zone of a person's face, comprising nose and mouth areas, and comprising:
a temperature and humidity sensor adapted to be activated when the mask is worn, and adapted to provide time-related data concerning said activation as well as temperature and humidity values;
removable air filter elements applied to the front side parts of the mask;
inhalation and exhalation valves applied to the front zone of the mask, in front of the mouth, when the mask is worn;
elements for securing the mask to the face;
an electronic nose device adapted to provide, when worn by the person, time-related data about the quality of the air in said working environment;
a breathing detection device, adapted to provide, when worn by the person, time-related data about the respiratory rate;
a data processing and displaying device, adapted to receive and store the data outputted by said protective facial mask, electronic nose device and breathing detection device, also adapted to process and display said data in order to determine a condition wherein said protective facial mask needs to be worn.

2. The system according to claim 1, wherein said elements for securing the mask to the face comprise a seal applied to the rear edge of the mask, to ensure adhesion thereof to the face, said seal being made of thermoformed fabric material padded with soft foam.

3. The system according to claim 1, wherein said electronic nose device (3) comprises a VOC value sensor, and said time-related data about the quality of the air are data concerning the VOC value.

4. The system according to claim 1, wherein said temperature and humidity sensor comprises an activation switch adapted to generate said time-related data concerning said activation.

5. The system according to claim 1, wherein said data processing and displaying device is adapted to generate said data displays of a first type concerning the number of times that said mask has been worn and not worn, and indicating when a threshold value of said VOC value has been exceeded.

6. The system according to claim 1, wherein said data processing and displaying device is adapted to generate data displays of a second type relating to a graphic organization of said time-related data about the number of times that said mask has been worn and not worn, said quality of the air, and said respiratory rate.

7. A method of using said multi-sense system according to claim 1, the method comprising the steps of:
providing said electronic nose device and said breathing detection device worn by a person;
sending the data generated by said electronic nose device and said breathing detection device to said data processing and displaying device;
using the data sent to said data processing and displaying device to determine a condition wherein said protective facial mask needs to be worn.
